(19) United States
(12) Patent Application Publication
(10) Pub. No.: US 2025/0029341 A1
(43) Pub. Date: Jan. 23, 2025

(54) OBJECT IDENTIFICATION IN EXTENDED REALITY USING GESTURE RECOGNITION

(71) Applicant: Tacitly Inc., Rutland, VT (US)

(72) Inventors: Jeffrey A. DeJarnette, Rutland, VT (US); William C. Kuker, Fair Haven, VT (US); Dylan Beebe, Wallingford, VT (US)

(21) Appl. No.: 18/356,266

(22) Filed: Jul. 21, 2023

(51) Int. Cl. G06T 19/00; G02B 27/01; G06F 3/01

(52) U.S. Cl. CPC G06T 19/006; G02B 27/01; G06F 3/017

(57) ABSTRACT

A system and method identifies objects in an XR environment using gesture recognition. For example, a user may point to an object in the XR environment, which triggers a small U.I. tag to pop up with additional information about the object. The system and method can be used in various applications, including identifying items in a medical code cart during a simulated or actual medical emergency situation.

### BACKGROUND

### 1. Technical Field

The present disclosure relates generally to extended reality (XR) environments and, more specifically, to a method for identifying objects in an XR environment using gesture recognition technology.

### 2. Description of the Related Art

Code carts are common in hospital settings and are used to store emergency medical supplies and equipment. It is crucial for healthcare professionals to quickly and accurately identify the correct items from the code cart during an emergency situation to ensure proper patient care.

Current practice for many facilities regarding code cart education includes the use of a demonstration cart. Mock code carts are filled with pre-opened supplies to prevent waste, often similar yet different replications to current models, and have minimal availability to supply all areas and cover each individual in need of training.

Code carts are a wonderful way to ensure that crucial equipment is readily available for healthcare providers responding to an emergency. Caring for acutely ill patients in the hospital setting, familiarizing oneself with the contents, specific location, and utilization of the code cart and its contents, is critical for ensuring timely and potentially life saving care.

Code carts are located on each unit and may differ in accessibility, locking mechanisms, layout of supplies, as well as contents. Supplies and their orientation often depend on the specific unit and the most common emergency situations in which they might experience.

Code cart familiarization is an opportunity for nurses and other important members of the healthcare team including providers and nursing assistants who are often present during these emergent events.

Having staff educated and prepared to initiate and aid in code cart utilization is imperative for teamwork and positive patient outcomes. Such education and training would benefit staff on orientation, when changes are made to the cart's contents or layout, and at frequent intervals called renewed education days, created to ensure those who have less real life opportunities to utilize the cart.

Initial and continued education enhances knowledge and familiarity, ensuring the recipient is fully prepared and comfortable with the before mentioned item. Similarly, those with regular exposure can ensure proper application and knowledge with respect to hospital policy and procedures.

As seen recently with the COVID-19 pandemic, many students as well as healthcare professionals were limited to their hands-on experiences. In fact, a number of individuals were forced to learn or work from home to minimize virus exposure. XR code cart use is a socially distant, remote application that could be utilized in education curriculum, as well as continued and initial training for students and professionals located in various locations including rural and urban areas. The importance of competence and confidence with code carts is something that cannot be stressed enough. The safety and wellbeing of patients depends on quick and efficient use and application of medical supplies in as little time as possible. Therefore, using a virtual program to prepare professionals on code cart use could mean the difference between minutes and seconds in terms of emergency response and patient outcomes.

Identifying the correct items in a code card, in a timely and efficient manner, can be challenging. This challenge is especially salient in high-pressure situations, which are common in code cart usage.

### SUMMARY

The present disclosure provides a system and method for identifying objects in an XR environment using gesture recognition. For example, the present system and method allows a user to point to an object in the XR environment, which triggers a small U.I. tag to pop up with additional information about the object. The system and method can be used in various applications, including identifying items in a medical code cart during a simulated or actual medical emergency situation.

In one form thereof, the present disclosure provides an extended reality system including a controller programmed with a digital twin of a physical object, a display operably connected to the controller and programmed to display the digital twin of the physical object, and a gesture recognition system operably connected to the controller. The gesture recognition system is configured to sense a pointing gesture by a user and output a signal to the controller indicative of the pointing gesture. The pointing gesture is directed toward the digital twin of the physical object. The controller is programmed to generate a U.I. tag including information about the physical object when the controller receives the signal indicative of the pointing gesture.

In another form thereof, the present disclosure provides an extended reality system including a physical object equipped with sensors or markers that generate or otherwise transmit signals indicative of physical properties of the physical object, a controller configured to receive the signals indicative of the physical properties, and programmed to output a digital twin of a physical object, a display operably connected to the controller and programmed to display the digital twin of the physical object, and a gesture recognition system operably connected to the controller and configured to sense a pointing gesture by a user and output a signal to the controller indicative of the pointing gesture. The pointing gesture is directed toward the digital twin of the physical object. The controller is programmed to generate a U.I. tag including an identity of the physical object when the controller receives the signal indicative of the pointing gesture.

In yet another form thereof, the present disclosure provides a method of identifying objects in an extended reality (XR) environment, including recognizing a pointing gesture directed toward or to a physical object, and in response to the step of recognizing, displaying a U.I. tag including information about the physical object on a display of an extended reality viewing system.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a schematic view of an extended reality system in accordance with the present disclosure, in use as a training device for code carts used by healthcare providers;

FIG. 2 is an example method in accordance with the present disclosure, depicting a sequence of steps to bring a user through an extended reality training scenario on a code cart;

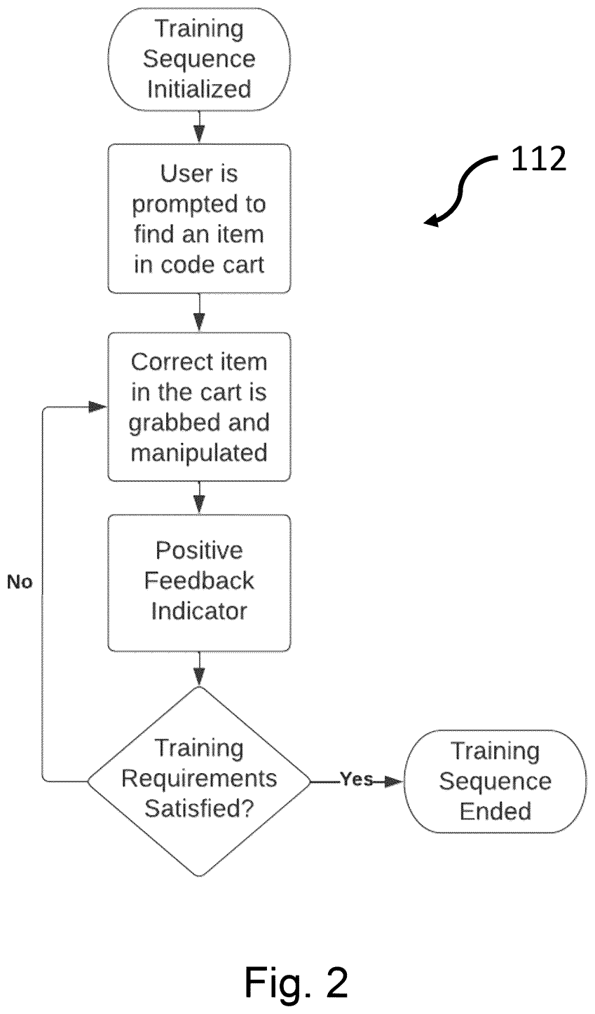

FIG. 3 is a schematic view of a user interface of the extended reality system shown in FIG. 1, illustrating a slider that allows adjustment of chaotic event frequency when a training mode is active, a scoring indicator, and a cart selection mode;

FIG. 4 is a cart configurator system of the extended reality system shown in FIG. 1, illustrating customization of the virtual code cart with varying cart layouts;

FIG. 5 is a view of an extended reality environment displayed by the system of FIG. 1, showing the appearance of a U.I. tag after a user points to an object displayed with the extended reality environment;

FIG. 6 is an example method of generating U.I. tags, according to some aspects provided herein;

FIG. 7 is a schematic control system in accordance with the present disclosure; and

FIG. 8 is a schematic device made in accordance with the present disclosure.

Corresponding reference characters indicate corresponding parts throughout the several views.

### DETAILED DESCRIPTION

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to an extended-reality system and method for object identification in the medical industry, other applications of the present system and method will be apparent to persons of ordinary skill in the art.

For purposes of the present disclosure, an “XR environment” is an extended-reality environment including characteristics associated with at least one of augmented reality (AR), virtual reality (VR), and mixed reality (MR), such that the XR environment can combine or mirror the physical world with a “digital twin” world able to interact with a user. Augmented reality (AR) may feature a combination of real and virtual worlds, with real-time interaction and accurate 3D registration of virtual and real objects. Virtual reality (VR) typically delivers a simulated experience that employs pose tracking and 3D near-eye displays to give the user an immersive feel of a virtual world. Mixed reality (MR) may merge a real-world environment and a computer-generated environment (e.g., with the use of haptics), such that physical and virtual objects may co-exist in the mixed reality environment with real-time interaction.

An XR system is used in accordance with the present disclosure to create an interactive display that can monitor a user's movements and reproduce a digital twin indicative of such movements on a display. Other objects may also be shown on the display, which may also be digital twins of real objects as required or desired for any particular application. These digital-twin objects may be superimposed with the digital-twin user movements on a single display, enabling virtual manipulation and interaction with the objects by the user.

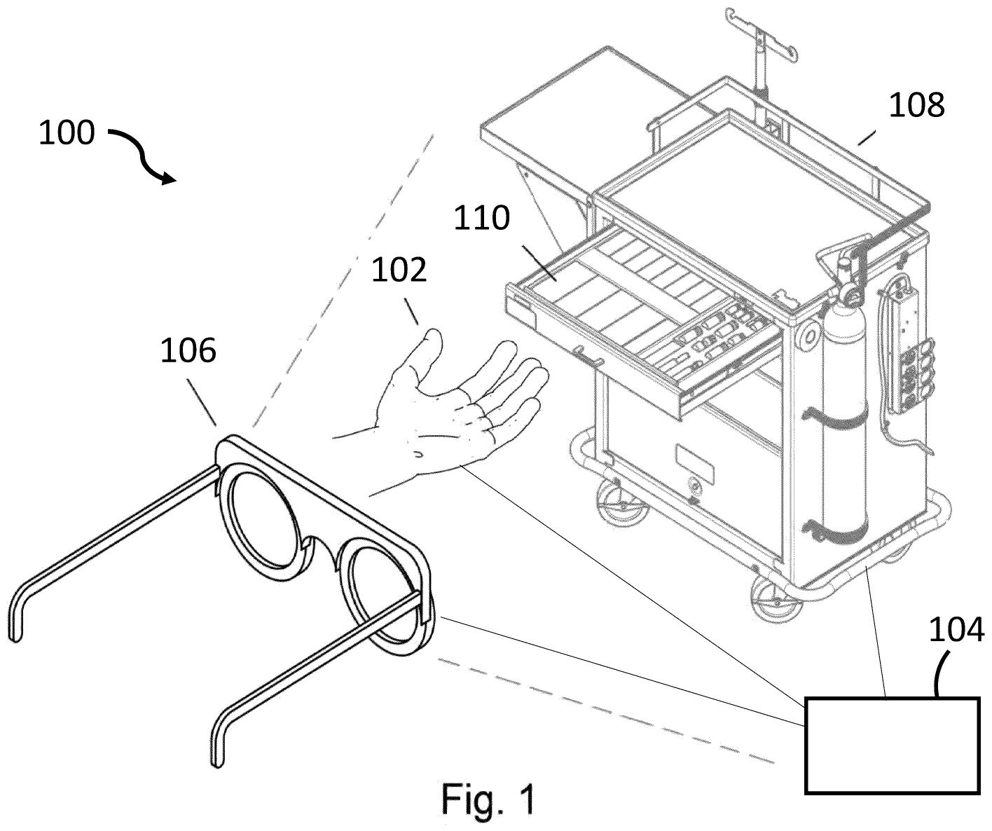

One exemplary XR system 100 suitable for use with the present disclosure is shown schematically in FIG. 1. System 100 includes a gesture recognition system 102, a computing device 104 programmed to generate and display an XR environment with gestures received from gesture recognition system 102, and a user display 106 capable of receiving and displaying the XR environment generated by the computing device 104 to a user of the XR system.

System 100 may include a commercially available XR headset programmed in accordance with the present disclosure. XR headsets contemplated for use in connection with the present disclosure include, for example, the Meta Quest Pro available from Meta Platforms, Inc. of Menlo Park, California. The XR headset may incorporate various parts of system 100 into a single unit, such as gesture recognition system 102 (i.e., in the form of one or more integrated cameras oriented toward the user's hands and capable of monitoring a user's hand movements), user display 106 (i.e., in the form of display screens positioned in the headset, worn on a user's face, such that the displays are positioned directly over the user's eyes), and at least a portion of computing device 104 (i.e., a computer capable of displaying a digital twin of the monitored hand movements from gesture recognition system 102 on display 106).

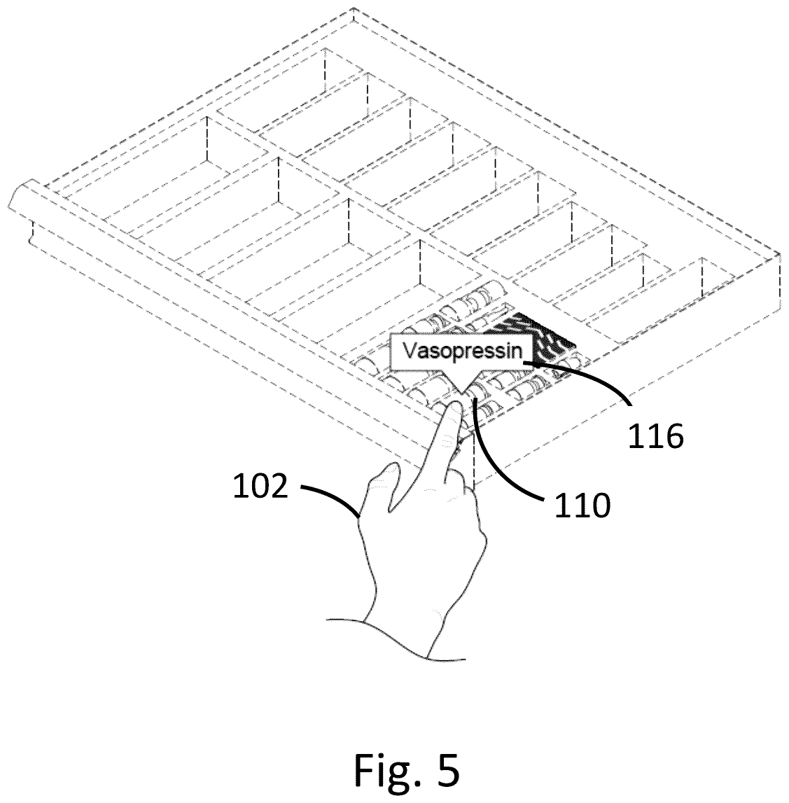

In one embodiment, the gesture recognition system 102 uses sensors or cameras to detect the user's physical gestures, such as pointing (FIG. 5). Computing device 104 translates these physical gestures into digital commands that are recognized by the XR environment. The XR environment may be a virtual or augmented reality environment that is displayed on the user device. The user device may be a smartphone, tablet, or other handheld device with a display.

### 1. Training

FIG. 1 illustrates extended reality (XR) system 100 capable of training a user on the operation of a physical object using a virtual digital “twin” 108 of the physical object. This digital twin 108 can be viewed and manipulated in the same way as the physical object. System 100 includes a gesture recognition system 102 with tracks movements, an extended reality viewing device 106, and a controller 104 which receives and issues digital signals indicative of the gesture recognition system 102 and digital twin 108 to and from viewing device 106, as detailed below.

In the illustrative embodiment of FIG. 1, a trainee-user uses an extended reality viewing device 106 to view a digital twin 108 of a physical code cart they are training for. This digital twin 108 is programmed into controller 104. The user can manipulate the digital twin 108 using gesture recognition system 102. For example, using gesture recognition system 102 (which may be camera based), the trainee can open the drawers and pick up and manipulate objects 110 inside the digital twin 108 of the physical code cart. The user does this by gesturing with their hands in space. In this way, the user can familiarize themselves with the layout of the code cart using only system 100, without the need for a physical code cart.

When the trainee is ready, they can command controller 104 to initialize a training scenario 112, shown schematically in FIG. 1. Controller 104 will then launch a program which guides the trainee through a simulated emergency situation with real world chaotic distractions. The trainee is asked to provide the necessary items within a certain time limit. If the trainee is successful in choosing the right items, they are given positive visual and aural feedback.

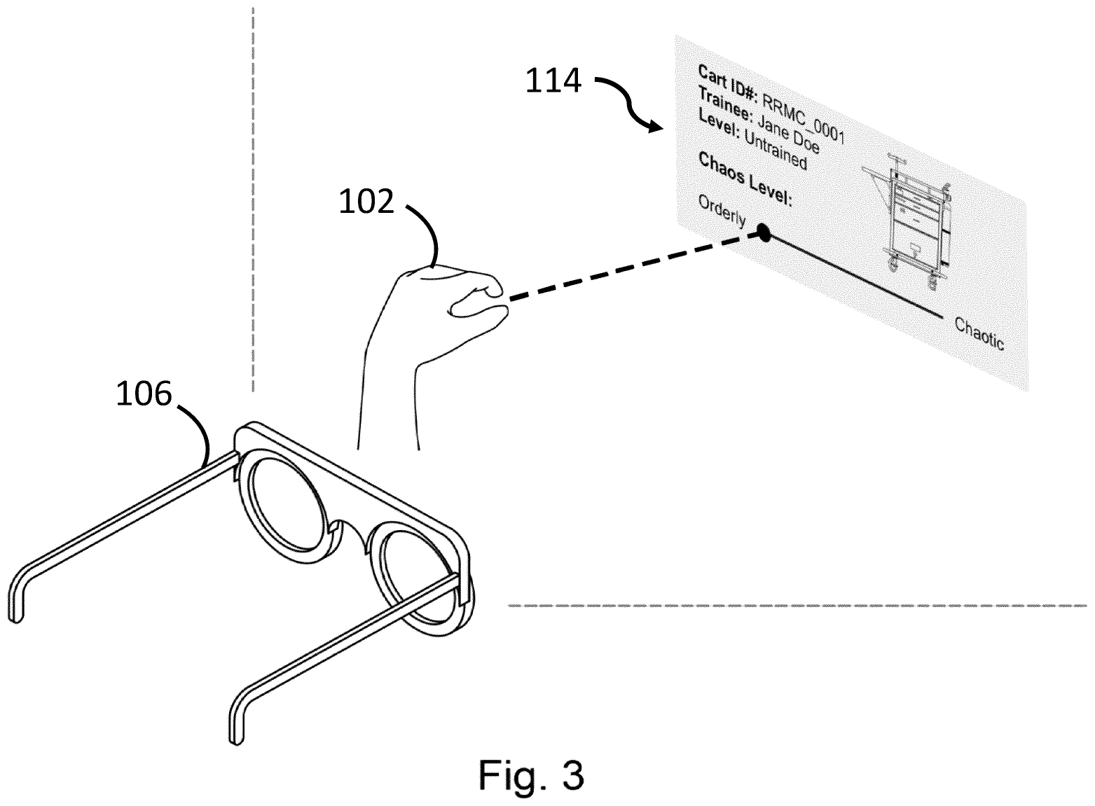

Referring to FIG. 3, a user interface may be programmed into controller 104. In particular, controller 104 may include a slider 114 which can be used to adjust the frequency of chaotic events. This allows for trainees and instructors to introduce distractions that prepare the trainee for real world use. The trainee can start out with no chaotic events (i.e., “orderly” as shown in FIG. 3), to familiarize themself with the layout, and then ramp up the chaos as needed (i.e., away from “orderly” and toward “chaotic” as shown in FIG. 3).

System 100 may also provide scoring and time measurements, stored on controller 104, so that the trainee can see their progress and improve. This assessment data can also be accessed by the trainee's instructor from any location, e.g., through a remote computer device connected to controller 104 via a wireless data connection as described further below. This wireless connectivity to controller 104 may allow a single instructor to manage several offsite locations. This assessment data can be used to validate the trainees' comprehension with the layout of the digital twin 108 (e.g., a code cart) and help certify them for real world use.

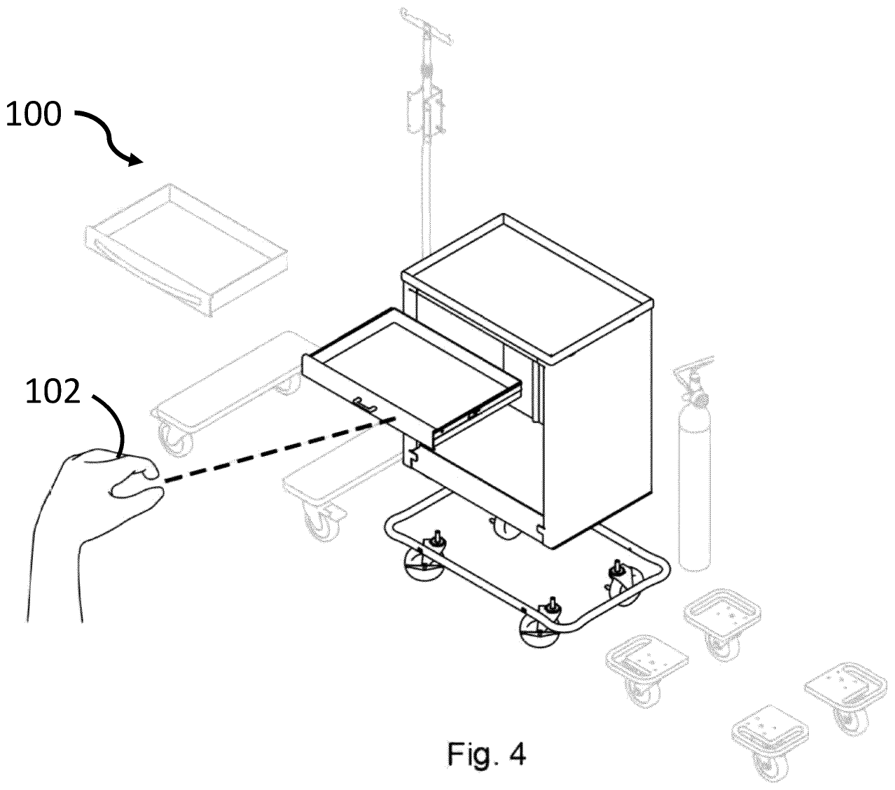

Turning now to FIG. 4, system 100 may also include a built-in cart configurator, to allow for the customization of the layout of the digital twin 108. This configuration may be customized by a user based on the institution's needs. It allows for cart style, custom drawer sizes, internal objects, and external objects to be changed, as shown in FIG. 4.

System 100 provides numerous benefits to code cart training and utilization. Through life-like simulation, students, doctors, and nurses in hospitals, schools, and other healthcare facilities can access a virtual digital twin 108 of a code cart (FIG. 1), familiarize themselves with the contents 110, manipulate the items for true application, and become confident in their ability to respond to an emergency, within their identified scope of practice. System 100 provides endless opportunities in regards to the ways in which it can benefit the healthcare profession.

### 2. Object Identification

Turning now to FIG. 5, the present disclosure provides a system and method for identifying objects in an XR environment using gesture recognition technology. The system may be system 100, described in detail above, or may include some components of system 100 as described further below. For purposes of the following discussion, the present object identification system will be described in terms of system 100, it being understood that not all features of system 100 are necessarily utilized in connection with the use of system 100 for object identification.

In one embodiment shown in FIG. 5, system 100 allows a user to direct a pointing gesture to or toward an object or a portion of an object in the XR environment using gesture recognition system 102. This pointing gesture triggers controller 104 to generate a user interface (“U.I.”) tag programmed with additional information about the object. As shown in FIG. 5, the U.I. tag appears on the display 106 with its own arrow pointing toward or to, or otherwise indicating, the identified object. The U.I. tag may include text, images, or other multimedia content related to the object.

In the illustrative example of FIG. 5, the user has used gesture recognition system 102 to point to object 110, which is a digital representation of a vial contained within a drawer. Controller 104 (FIG. 1) receives a signal indicative of this particular pointing gesture and is programmed to generate and display a U.I. tag 116. As shown in FIG. 5, tag 116 includes the word “Vasopressin” to indicate that the vial pointed to using gesture recognition system 102 indicates the location of a physical vial of human vasopressin which may be administered to a patient on orders from a doctor. The drawer illustrated in FIG. 5 may be a portion of the digital-twin code cart 108 shown in FIG. 1 and described in detail above, with the identified vial being one of the objects 110 contained within the digital-twin code cart 108. Of course, it is contemplated that other portions of the digital twin 108, such as other vials or objects contained within or forming a part of the code cart, may also be similarly identified with a pointing gesture and U.I. tag.

As shown in FIG. 5, the U.I. tag may be large enough to convey the desired information, but small enough to avoid completely covering nearby or adjacent objects which are also identifiable by a user's pointing gesture.

In one application, system 100 may be used to identify items in a physical medical code cart during an emergency situation. The medical code cart may be equipped with sensors or markers affixed to the code cart, or portions thereof. The sensors or markers generate or otherwise transmit signals readable by controller 104 that are indicative of physical properties of the physical code cart, such as its size, shape, contents, and position. Controller 104 is programmed to process these signals to output an accurate, real-time digital twin 108 of the physical code cart on the display 106, including its position, size, shape, and contents. For example, each of a plurality of items contained within a drawer of the code cart may include a unique marker that can be detected by system 100 (e.g., by cameras of the gesture recognition system 102), and controller 104 may be programmed with further information about each object to which a respective marker is attached. This further information may be displayed as object 110 in the user display 106. This display may be triggered by the pointing gesture, as described above, such that a user's gestures can be used to selectively identify the physical items in the code cart. U.I. tag 116 may provide information about the corresponding physical item, such as its name, its purpose or function, and its location in the cart.

System 100 provides several advantages over traditional methods of object identification, such as manual searching or reading labels. For example, system 100 enables healthcare professionals to quickly and accurately identify desired physical items in an emergency situation, which can save valuable time and improve patient outcomes.

It is also contemplated that system 100 can be adapted for use in other fields, such as aerospace, retail or manufacturing, or any other context where object identification and recognition are desired. For example, a digital twin of any device or system may be programmed into controller 104 and virtually manipulated by a user in the manner described above with respect to code cart 108. For purposes of the present disclosure, system 100 has been described with respect to code cart 108 and its related contents and environment, it being understood that system 100 is equally applicable to other systems, devices and environments as required or desired for a particular application. Examples of systems that can be digitally replicated and manipulated using system 100 include aircraft control panels, manufacturing environments and retail warehouses, for example. Other systems amenable for use with system 100 in accordance with the present disclosure include server racks used in connection with information technology (IT) systems, which have components identifiable using system 100. Yet another application of system 100 is assembly of products from instructions, such as furniture, in which a user may point to parts to verify their identification and learn how to integrate the parts into the larger assembly according to the preprogrammed instructions.

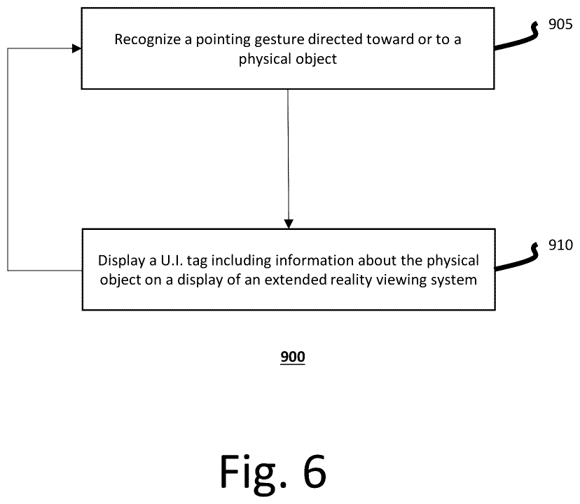

FIG. 6 illustrates one possible method 900 of object identification in accordance with the present disclosure. In step 905, a system such as system 100 recognizes a pointing gesture directed toward or to a physical object. Next, at step 910, the system displays a U.I. tag including information about the physical object on a display of an extended reality viewing system. The method loops back to step 905 to recognize a new (or the same) pointing gesture, and display a new (or the same) U.I. tag. In this way, the method 900 can be used to iteratively, constantly display U.I. tags based on the pointing gesture(s) provided by a user and recognized by the system.

### 3. Computing Systems

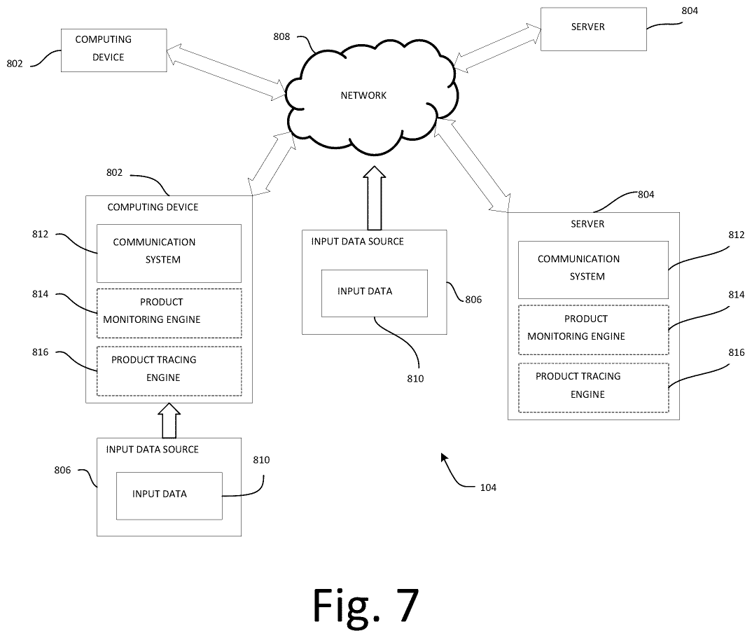

Turning to FIG. 7, controller 104 is shown schematically in one possible configuration. As illustrated, controller 104 may include computing device 802 and/or server 804, which can be any suitable computing device or combination of devices, such as a controller, desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some examples, controller 104 may include a plurality of computing devices 802 and/or a plurality of servers 804.

In some examples, input data source 806 can be any suitable source of input data (e.g., data generated from a computing device, data stored in a repository, data generated from a software application, data received from a temperature probe, data received from a sensor, etc.). In some examples, input data source 806 can include memory storing input data (e.g., local memory of computing device 802, local memory of server 804, cloud storage, portable memory connected to computing device 802, portable memory connected to server 804, etc.). In some examples, input data source 806 can include an application configured to generate input data and provide the input data via a software interface. In some examples, input data source 806 can be local to computing device 802. In some examples, input data source 806 can be remote from computing device 802, and can communicate input data 810 to computing device 802 (and/or server 804) via a communication network (e.g., communication network 808). Input data source 806 can include sources of display and/or gesture data as described herein. In some examples, the input data source 806 may include data received from cameras and/or sensors in connection with gesture recognition system 102, data programmed into controller 104 by a user such as via slider 114 (FIG. 3), etc.

In some examples, the input data 810 may include identification and/or spatial location information relating to the digital twin 108 and any objects 110 contained within or associated with the digital twin 108. Additional and/or alternative attributes of the input data 810 may be recognized by those of ordinary skill in the art at least in light of teachings provided herein.

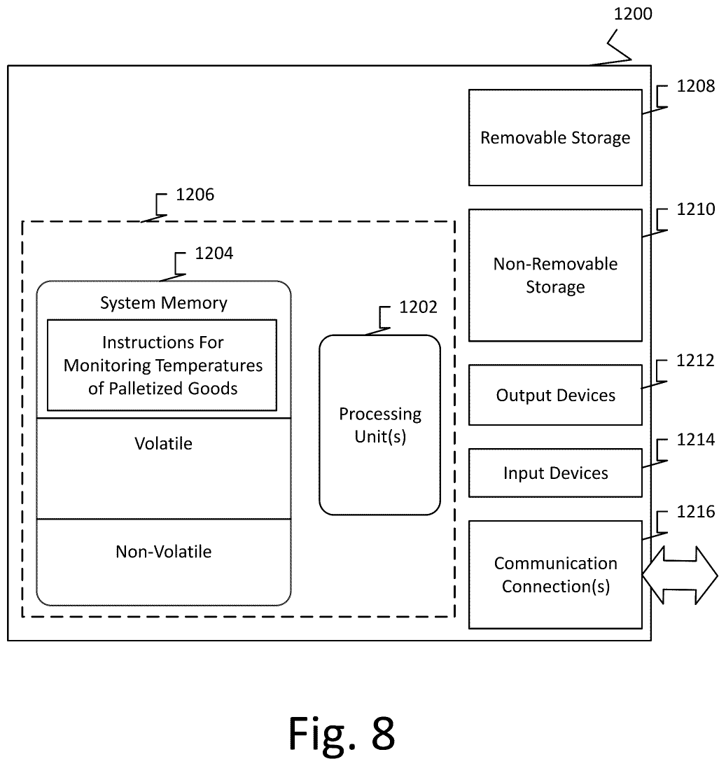

FIG. 8 illustrates a simplified block diagram of a device with which aspects of the present disclosure may be practiced in accordance with aspects of the present disclosure. The device may be a mobile computing device, for example. One or more of the present embodiments may be implemented in an operating environment 1200. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1200 typically includes at least one processing unit 1202 and memory 1204. Depending on the exact configuration and type of computing device, memory 1204 (e.g., instructions for one or more aspects disclosed herein, such as one or more aspects of methods/processes discussed herein) may be volatile (such as RAM), non-volatile (such as ROM, flash memory, etc.), or some combination of the two. This most basic configuration is illustrated in FIG. 8 by dashed line 1206. Further, the operating environment 1200 may also include storage devices (removable, 1208, and/or non-removable, 1210) including, but not limited to, magnetic or optical disks or tape, flash drives, solid-state drives (SSD), and the like. Similarly, the operating environment 1200 may also have input device(s) 1214 such as remote controller, keyboard, mouse, pen, voice input, on-board sensors, etc. and/or output device(s) 1212 such as a display, speakers, printer, motors, etc. Also included in the environment may be one or more communication connections 1216, such as LAN, WAN, a near-field communications network, a cellular broadband network, point to point, etc.

Operating environment 1200 typically includes at least some form of computer readable media. Computer readable media can be any available media that can be accessed by the at least one processing unit 1202 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, flash drives, solid-state drives (SSD), or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1200 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An extended reality system comprising:
a controller programmed with a digital twin of a physical object;
a display operably connected to the controller and programmed to display the digital twin of the physical object; and
a gesture recognition system operably connected to the controller and configured to sense a pointing gesture by a user and output a signal to the controller indicative of the pointing gesture, wherein the pointing gesture is directed toward the digital twin of the physical object,
the controller programmed to generate a U.I. tag including information about the physical object when the controller receives the signal indicative of the pointing gesture.

2. The extended reality system of claim 1, further comprising the physical object equipped with sensors or markers that generate or otherwise transmit signals indicative of physical properties of the physical object.

3. The extended reality system of claim 2, wherein the controller is programmed to process the signals indicative of physical properties and output the digital twin.

4. The extended reality system of claim 1, wherein the digital twin of the physical object is a portion of a medical code cart.

5. The extended reality system of claim 1, wherein the U.I. tag includes an arrow pointing to or toward the digital twin of the physical object.

6. The extended reality system of claim 1, wherein the information about the physical object includes an identity of the physical object.

7. The extended reality system of claim 1, wherein the gesture recognition system comprises one or more cameras.

8. The extended reality system of claim 1, wherein the display is formed as a portion of an extended reality viewing system.

9. The extended reality system of claim 8, wherein the display is configured to be worn on a user's face such that the displays are positioned directly over the user's eyes.

10. The extended reality system of claim 8, wherein the gesture recognition system comprises one or more cameras integrated into the extended reality viewing system.

11. An extended reality system comprising:
a physical object equipped with sensors or markers that generate or otherwise transmit signals indicative of physical properties of the physical object;
a controller configured to receive the signals indicative of the physical properties, and programmed to output a digital twin of a physical object;
a display operably connected to the controller and programmed to display the digital twin of the physical object; and
a gesture recognition system operably connected to the controller and configured to sense a pointing gesture by a user and output a signal to the controller indicative of the pointing gesture, wherein the pointing gesture is directed toward the digital twin of the physical object,
the controller programmed to generate a U.I. tag including an identity of the physical object when the controller receives the signal indicative of the pointing gesture.

12. The extended reality system of claim 11, wherein the gesture recognition system comprises one or more cameras.

13. The extended reality system of claim 11, wherein the digital twin of the physical object is a portion of a medical code cart.

14. The extended reality system of claim 11, wherein the U.I. tag includes an arrow pointing to or toward the digital twin of the physical object.

15. A method of identifying objects in an extended reality (XR) environment, comprising:
recognizing a pointing gesture directed toward or to a physical object; and
in response to the step of recognizing, displaying a U.I. tag including information about the physical object on a display of an extended reality viewing system.

16. The method of claim 15, wherein the pointing gesture comprises a user's hand movement.

17. The method of claim 16, wherein the step of recognizing comprises recording the user's hand movement with a camera oriented toward the user's hand.

18. The method of claim 15, wherein the step of displaying comprises displaying an identity of the physical object.

19. The method of claim 15, further comprising:
receiving signals indicative of physical properties of the physical object, the signals transmitted by sensors or markers affixed to the physical object;
processing the signals indicative of physical properties;
based on the step of processing, outputting an accurate, real-time digital twin of the physical object on the display.

20. The method of claim 15, wherein a unique one of the sensors or markers is affixed to each of a plurality of items associated with the physical object, and the step of outputting includes outputting the U.I. tag for each of the items.
